(19) United States
(12) Patent Application Publication
(10) Pub. No.: US 2007/0110387 A1
(43) Pub. Date: May 17, 2007

(54) Advanced tactical display center

(76) Inventors: Kerry Bryan Flint, Seabeck, WA (US); Jeffery Jay Glanzman, Bremerton, WA (US); Kyle John Hansen, Poulsbo, WA (US); Kyle Mitchell Morris, Port Orchard, WA (US); Steven Charles Moss, Keyport, WA (US); Karl Richard Palm, Keyport, WA (US); Donald Joseph Warner, Seattle, WA (US)

Correspondence Address: Ryan Stamper;Naval Undersea Warfare Center, Division Keyport, Bldg 82, Code 00L, 610 Dowell St, Keyport, WA, 98345-7610, US

(21) Appl. No.: 11/273,453

(22) Filed: Nov. 14, 2005

(51) Int. Cl. G02B 6/00

(52) U.S. Cl. 385/147

(57) ABSTRACT

A display center for a weapons control system consisting of a frame including front leg rails, rear leg rails, side rail supports, a top plate, a rear cross-bracket, a bottom plate, a monitor area and a removable electronics box. The display center may include an upper monitor, a lower monitor and a monitor support and an integrated keyboard and trackball.

### STATEMENT OF GOVERNMENT INTEREST

The invention described herein may be manufactured and used by or for the Government of the Untied States of America for governmental purposes without the payment of any royalties thereon or therefore.

### BACKGROUND

1. Field of the Invention

The present invention relates generally to a display center and more specifically to a display center for a weapons control system.

2. Description of the Related Art

There is a compelling need to improve on the current design philosophy of display centers, particularly those in military-use, including those used for weapons control systems aboard Naval and other military vessels. Such display centers must be capable of withstanding significant shock and vibration forces to ensure they will remain functional in their operating environment.

Previous display centers were custom fit to the technology available at the time of design, making them costly and difficult or impossible to reconfigure as technology evolves. It is equally difficult to find replacement items for those used in the original design once that technology becomes obsolete. To mitigate this problem, the present invention is drawn to a display center design that meets required shock and vibration tests in a modular, easily reconfigurable system with improved ergonomics. In addition, this system will be able to be produced at a significant cost reduction in comparison with existing military display centers.

### SUMMARY OF THE INVENTION

To achieve the foregoing, and in accordance with the purposes of the present invention as embodied and broadly described herein, it is an object of this invention to provide an improved display center for a weapons control system.

In a preferred embodiment, the display center of the present invention utilizes good ergonomic practices by aligning flat panel displays and a keyboard and allocating more space for the user.

The design of the present invention allows the components of the display center, including the electronics, keyboard, and flat panel displays to remain functional during normal shipboard operating conditions or in the presence of a blast event. In particular, the display center is qualified to handle high levels of shock and vibration and is able to pass required shock and vibration tests.

In a preferred embodiment, the frame is a high-strength aluminum extrusion utilizing a T-slot design to decrease cost and allow for future upgrades. The joints are made up of custom steel and aluminum brackets and gussets that provide enough strength and damping to the system for it to pass required shock and vibration tests. The electronics, other than the displays and keyboard, may be mounted to the frame in a modular enclosure that may be removed and replaced with minimal alterations to the frame.

### BRIEF DESCRIPTION OF THE DRAWINGS/FIGURES

The accompanying drawings, which are incorporated in and form a part of this specification, illustrate embodiments of the invention and, together with the description, serve to explain the principles of the invention and to enable a person skilled in the relevant art to make and use the invention:

FIG. 1 shows a perspective front view of the display center of the present invention.

FIG. 2 shows a perspective rear view of the display center of the present invention.

### DETAILED DESCRIPTION OF THE PREFERRED EMBODIMENTS

The present invention will now be described with reference to the accompanying drawings. In the drawings, like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other devices and applications.

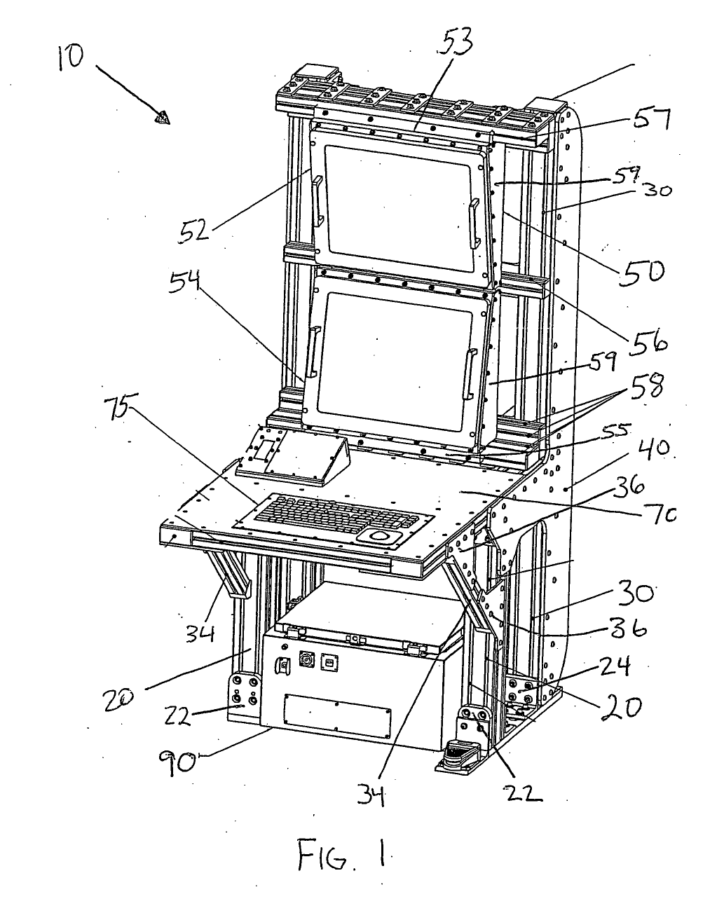

The composition of the present invention is a display center 10. In a preferred embodiment, display center 10 is for Tomahawk weapons control systems aboard Naval vessels. As shown in FIG. 1, display center 10 includes front leg rails 20. In a preferred embodiment, front leg rails 20 have a square base, preferably between approximately 80 and 100 millimeters, and most preferably approximately 90 millimeters. Preferably front leg rails 20 are between approximately 25 and 26 inches tall, and most preferably approximately 25.730 inches tall.

The embodiment shown in FIG. 1 further includes rear leg rails 30. In a preferred embodiment, rear leg rails 30 have a square base, preferably between approximately 80 and 100 millimeters, and most preferably approximately 90 millimeters. Preferably rear leg rails 30 are between approximately 65 and 66 inches tall, and most preferably approximately 65.632 inches tall. However, in alternate embodiments, real leg rails 30 could be shorter or taller, particularly if display center includes a single monitor or multiple monitors. In a preferred embodiment, front leg rails 20 and rear leg rails 30 are extruded aluminum, however other materials and methods of production may be used, as would be known to one skilled in the relevant art.

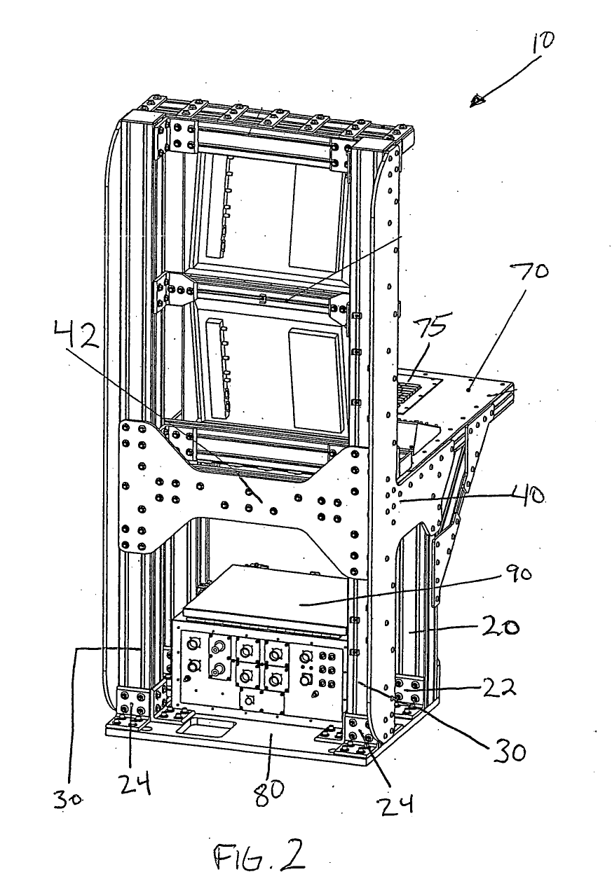

As shown in the embodiment in FIG.2, display center 10 further includes a bottom plate 80. Preferably bottom plate 80 is between approximately 28 and 30 inches wide, approximately 20 and 22 inches long, and approximately 0.75 inches deep. As shown in FIG. 2, bottom plate 80 is coupled to front leg rails 20 and rear leg rails 30. In a preferred embodiment, front leg rails 20 are coupled to bottom plate 80 with front leg mounting brackets 22, as shown in FIG. 1. Similarly, rear leg rails 30 are coupled to bottom plate 80 with rear leg mounting brackets 24. In a preferred embodiment, mounting brackets 22 and 24 are coupled to leg rails 20 and 30 and bottom plate 80 with four bolts spaced equidistance in a square pattern as shown in FIG. 1, however, in alternate embodiments, said coupling may use fewer or more bolts in varying patterns as would be known to one skilled in the relevant art. Although bolts are preferably, any coupling method could be substituted such as screws, welding, posts, or any other type of coupling as would be known to one skilled in the relevant art.

Display center 10 further includes a top plate 70 attached to leg rails 20 and 30. In a preferred embodiment, top plate 70 includes a keyboard and trackball 75 as shown in FIG. 1.

In a preferred embodiment, display center 10 includes a monitor area 50. In the embodiment shown in FIG. 1, monitor area 50 includes an upper monitor support 57, a middle monitor support 56 and a lower monitor support 58. In a preferred embodiment, middle monitor support 56 is an approximately rectangular aluminum bar, and upper and lower monitor supports 57 and 58 consist of two approximately rectangular aluminum bars arranged perpendicular to each other. In the embodiment shown in FIG. 1, monitor area 50 further includes an upper monitor frame 53 and a lower monitor frame 55. Monitor frames may preferably be approximately 45 mm by 45 mm frames, which are approximately 19 inches wide, approximately 19 inches high and approximately 0.75 inches deep. In a preferred embodiment, monitor supports and monitor frames are extruded aluminum, although other similar materials could be used as would be known to one skilled in the relevant art. In a preferred embodiment, a lower monitor 54 is located in lower monitor frame 55 and an upper monitor 52 is located in upper monitor frame 53. Preferably, monitors 52 and 54 are flat panel monitors, although any type of alternate display monitors could be used as would be known to one skilled in the relevant art. Although two monitors are shown in FIG. 1, in alternate embodiments, monitor area 50 may include a single monitor, or a plurality of monitors, such as three, four, six, eight, or any number of monitors as would be known by one skilled in relevant art.

Display center 10 further includes monitor side plates 59, angle rails 34 and angle rail support plates 36 which are designed to allow display center 10 to withstand required shock tests. In a preferred embodiment, monitor slide plates 36 are 3.5 inch square aluminum. Preferably, angle rails 34 are connected approximately midway on front leg rails 20 and to top plate 70 at approximately a 45 degree angle and help support top plate 70. Angle rail support plates 36 are preferably coupled to angle rails 34 through bolts or other coupling methods as would be known to one skilled in the relevant art.

In a preferred embodiment, display center 10 further includes a removable electronics box 90, including a power supply and converters. Removable electronics box 90 is modulized and detachable from display center 10 to facilitate repairs and/or for use with other systems. In a preferred embodiment, removable electronics box 90 is boltable to display center 10, although in alternate embodiments, any means of removable attachment may be used, as would be known to one skilled in the relevant art. In a preferred embodiment, electronics box 90 utilizes an AC to DC power supply. In a preferred embodiment, electronics box utilizes fiber optic red-green-blue converters. In one embodiment of the present invention, converters interface fiber optic receiver cards with shrink tubing. Additionally, different electronics may be included in electronics box 90, such as a thin client CPU.

In a preferred embodiment, display center includes side rail support plate 40, as shown in FIGS. 1 and 2. Side rail support plate 40 is designed as a single piece and runs along the length of rear leg rail 30 and connects to front leg rail 20 and top plate 70. In a preferred embodiment, side rail support plate 40 is bolted to rear leg rail 30, front leg rail 20 and top plate 70, although side rail support plate 40 may be connected in any other suitable way, as would be known to one skilled in the relevant art. Side rail support plate 40 is designed to withstand required shock and vibration tests. In a preferred embodiment, side rail support plate 40 is ⅜-inch aluminum plating, although other dimensions suitable to withstand shock and vibrations may be used as would be known to one skilled in the relevant art.

In the perspective rear view shown in FIG. 2 of a preferred embodiment of the present invention, display center 10 includes a rear support plate 42. In a preferred embodiment, rear support plate 42 is a single piece and is X-shaped and connected to rear leg rails 30 at a vertical distance approximately at the location of top plate 70. In a preferred embodiment, rear support plate 42 is bolted to rear leg rails 30, however, any other suitable method of connection may be used, as would be known to one skilled in the relevant art. Rear support plate 42 is designed to withstand required shock and vibration tests. In a preferred embodiment, rear support plate 40 is ⅜-inch aluminum plating, although other dimensions suitable to withstand shock and vibrations may be used as would be known to one skilled in the relevant art.

### EXAMPLE 1

The following shock and vibration tests were performed on a display center of the present invention. A remote test station was used to conduct functionality testing of the display center subsequent to all shock and vibration tests.

The display center was subjected to high-impact shock testing to determine its suitability for use under the effects of severe shock input that may be incurred during its use. A Medium Weight Shock Machine was used to conduct the high impact shock test. A standard mounting platform was used for the vertical blows and a 30-degree fixture was used for the inclined blows. Accelerometers were attached to the display center in the vertical and horizontal directions. The display center was energized throughout the shock test, and a remote test station was used to conduct functionality testing prior and subsequent to all shock blows. Table 1 contains a synopsis of nine blows conducted on the display center.

TABLE 1

| Blow | | Hammer height | Table travel |
|---|---|---|---|
| Number | Direction | (feet) | (inches) |
| 1 | Vertical | 1 | 3 |
| 2 | Vertical | 2 | 3 |
| 3 | Vertical | 2 | 1.5 |
| 4 | 30° side to side | 1.25 | 3 |
| 5 | 30° side to side | 2.25 | 3 |
| 6 | 30° side to side | 2.25 | 1.5 |
| 7 | 30° front to back | 1.25 | 3 |
| 8 | 30° front to back | 2.25 | 3 |
| 9 | 30° front to back | 2.25 | 1.5 |

The base plate of the display center was bolted to a two inch thick aluminum plate test fixture measuring 36 inches by 36 inches using six machine screws tightened to a torque of 75 foot-pounds. The test fixture was affixed to Cardbuilder channels using four 1-inch thick T-blocks. One inch thick spacers were used between the fixture and Carbuilder channels. Based on the equipment weight and the 30 inch mounting hole spacing, two Carbuilder channels were used. Four standard channels, equivalent to two Carbuilder channels, were used to comprise two beams that supported the display center.

### EXAMPLE 2

Mechanical vibration tests were conducted on the display center to show the display center can continue to operate while be subjected to vibration levels that may be encountered during adverse conditions. The vibration testing was conducted up to a frequency of 25 Hertz.

The vibratory motion input to and response of the display center was measured with piezoelectric accelerometers, the outputs of which were conditioned using charge amplifiers. Prior to the vibration test, the accelerometers and measurement system were field-calibrated using an accelerometer calibrator with the capability of vibrating at one Grms at 159 Hertz.

The display center was mounted to the same two inch thick aluminum test fixtures used in the shock tests described in Example One above. The fixture was secured to the vibration machine using 20 machine screws. The vibration test consisted of three separate phases, an exploratory test, a variable frequency test, and an endurance test.

Exploratory Test—In order to determine if any mechanical resonances were present, an exploratory swept-sine test was performed. The display center was vibrated from 4-25 Hertz at a table vibratory double-amplitude displacement of 0.02 inches. The transmissibility between the input and the accelerometers on the display center was measured during the exploratory test.

Variable Frequency Test—A variable frequency test was conducted, which consisted of vibrating the display center from 4-25 Hertz in one-Hertz discrete-frequency intervals that were each maintained for five minutes. The amplitude of vibration is contained in Table 2.

TABLE 2

| Frequency Range (Hz) | Displacement (inch, peak to peak) |
|---|---|
| 4-15 | 0.060 ± 0.012 |
| 16-25 | 0.040 ± 0.008 |

Endurance Test—Based on the fact that no resonance was detected during the exploratory or variable frequency tests, the endurance test was performed at the maximum frequency of 25 Hertz in all three directions (vertical, side to side, and front to back) for a period of two hours. The displacement was set to 0.020 inches. The operability of the display center was monitored throughout the endurance tests.

TABLE 3

| | | Transmissibility | | Transmissibility | | Transmissibility |
|---|---|---|---|---|---|---|
| Location | Direction | at 25 Hz | Direction | at 25 Hz | Direction | at 25 Hz |
| Bullnose | Front-back | 2.0 (2.1) | Side-side | 4.8 (6.4) | Vertical | 1.0 (1.0) |
| FPD | Front-back | 3.9 (4.0) | Side-side | 5.2 (7.1) | Vertical | 1.2 (1.2) |
| Frame | Front-back | 4.8 (4.9) | Side-side | 6.1 (8.2) | Vertical | 1.0 (1.0) |

“( )” denotes transmissibility measured during Variable Frequency Tests

While the invention has been particularly shown and described with reference to preferred embodiments thereof, it will be understood by those of ordinary skill in the art that various changes in form and details may be made therein without departing from the spirit and scope of the invention or any embodiment thereof. It will be apparent to a person skilled in the relevant art that this invention can also be employed in a variety of other devices and applications. All patents, patent applications and publications cited herein are fully incorporated by reference herein in their entirety.

What is claimed is:

1. A display center, comprising:
a plurality of front leg rails;
a plurality of rear leg rails;
a bottom plate coupled to said rear leg rails and said front leg rails;
a monitor area;
a top plate connected to said rear leg rails and said front leg rails;
at least one side support rail connected to the outside of said rear leg rails; and
an electronics box removably located above said bottom plate.

2. The display center of claim 1, wherein said bottom plate is coupled to said rear leg rails and said front leg rails by at least one mounting plate.

3. The display center of claim 2, wherein said at least one mounting plate is coupled by bolt construction.

4. The display center of claim 1, further comprising a plurality of angle rails connected at approximately 45 degree angles to said front leg rails and said top plate.

5. The display center of claim 1 further comprising a rear plate connected to said at least one side support rail.

6. The display center of claim 5, wherein said rear plate is located below said monitor area.

7. The display center of claim 1, wherein said monitor area comprises at least one monitor.

8. The display center of claim 1, wherein said monitor area comprises a plurality of monitors.

9. The display center of claim 8, wherein said plurality of monitors comprises an upper monitor and a lower monitor.

10. The display center of claim 9, wherein said monitors are flat panel displays.

11. The display center of claim 8, wherein said plurality of monitors comprises at least six monitors.

12. The display center of claim 1, wherein said top plate further comprises a keyboard.

13. The display center of claim 9, wherein said monitor area further comprises a monitor support located between said upper monitor and said lower monitor.

14. The display center of claim 1, further comprising at least one monitor side plate.

15. The display center of claim 1, wherein said electronics box includes a power supply.

16. The display center of claim 1, wherein said electronics box further includes at least one converter.

17. The display center of claim 16, wherein said at least one converter is at least one fiber optic converter.

18. The display center of claim 1, further comprising a lower monitor support and an upper monitor support.

19. A display center, comprising:
a plurality of front leg rails;
a plurality of rear leg rails;
a bottom plate coupled to said rear leg rails and said front leg rails;
a monitor area including an upper monitor support, a middle monitor support, a lower monitor support, an upper monitor and a lower monitor, wherein said upper monitor is connected to said upper monitor support and said middle monitor support, and wherein said lower monitor is connected to said middle monitor support and said lower monitor support;
a removable electronics box;
a top plate connected to said rear leg rails and said front leg rails;
at least one side support rail connected to the outside of said rear leg rails.

20. A display center, comprising:
a plurality of front leg rails;
a plurality of rear leg rails;
a bottom plate coupled to said rear leg rails and said front leg rails;
a monitor area;
a top plate connected to said rear leg rails and said front leg rails;
at least one side support rail connected to the outside of said rear leg rails.

21. The display center of claim 20, further comprising an electronics box.

22. The display center of claim 21, wherein said electronics box is removably located above said bottom plate.
